(19) United States
(12) Patent Application Publication
(10) Pub. No.: US 2009/0174317 A1
(43) Pub. Date: Jul. 9, 2009

(54) Display device having a transparent protective display unit

(76) Inventors: Woo-Suk Jung, Suwon-si (KR); Duk-Jin Lee, Suwon-si (KR); Noh-Min Kwak, Suwon-si (KR); Gi-Na Yoo, Suwon-si (KR); Min-Jae Kim, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/292,537

(22) Filed: Nov. 20, 2008

(30) Foreign Application Priority Data
Jan. 9, 2008 (KR) 10-2008-0002587

(51) Int. Cl. G02B 5/00; H01J 9/20

(52) U.S. Cl. 313/504; 359/507

(57) ABSTRACT

A display device that increases visibility and that reduces the entire thickness of the device and is suitable for mobile appliances and other applications. The display device includes a display panel that has a display area and a non-display area, a transparent protective unit that is positioned at the front of the display panel, an adhesive layer that is formed between the display area and the transparent protective unit to attach the transparent protective unit to the display panel, an adhesive tape that is positioned between the non-display area and the transparent protective unit while enclosing the adhesive layer, and a bezel that is coupled to the display panel at the rear of the display panel. The adhesive tape forms at least one opening.

### CLAIM OF PRIORITY

This application makes reference to, incorporates the same herein, and claims all benefits accruing under 35 U.S.C. §119 from an application for DISPLAY DEVICE earlier filed in the Korean Intellectual Property Office on 9 Jan. 2008 and there duly assigned Serial No. 10-2008-0002587.

### BACKGROUND OF THE INVENTION

1. Field of the Invention

The present invention relates to a display device. More particularly, the present invention relates to a transparent protective unit that is positioned at the front of a display panel to protect the display panel.

2. Description of the Related Art

Organic light emitting diode (OLED) display device use an OLED display panel to display images. The OLED display panel includes organic light emitting elements that include an anode electrode which is a hole injection electrode, an organic emission layer, and a cathode electrode which is an electron injection electrode. When the anode electrode and the cathode electrode inject holes and electrons, respectively, to the organic emission layer, excitons to which electrons and holes are coupled are generated within the organic emission layer, and light emitting is performed by energy generated when the excitons drop from an exited state to a ground state.

An active matrix type of OLED display panel includes pixels on a substrate arranged in a matrix format, and a thin film transistor (TFT) as a switching element is disposed in each pixel to independently control the corresponding pixel.

A display device having the OLED display panel or other display panels can be applied to small mobile appliances such as a cellular phone, a personal digital assistant (PDA), and a portable multimedia player (PMP). In this case, the display device should have excellent visibility, a small thickness, and excellent impact resistance.

In a conventional display device, a lower bezel is provided at the rear of the display panel to fix and support the display panel. An upper bezel having a transparent protective unit is provided at the front of the display panel to protect the display panel.

However, in a common case, the transparent protective unit is positioned apart the display panel with a predetermined gap therebetween. In this case, because light that is emitted from the display panel is emitted to the outside through the gap and the transparent protective unit, visibility is deteriorated due to a refractive index difference between the transparent protective unit and the gap and transmittance deterioration that is generated by the gap. Further, because the gap has a considerable thickness of about 0.5 mm or more, the gap functions as a detrimental element in making the display device slim.

The above information disclosed in this Related Art section is only for enhancement of understanding of the background of the invention and therefore it may contain information that does not form the prior art that is already known to a person of ordinary skill in the art.

### SUMMARY OF THE INVENTION

The present invention has been made in an effort to provide a display device having advantages of minimizing deterioration of visibility and reducing an entire thickness thereof to be more suitable for mobile appliances and other applications.

An exemplary embodiment of the present invention provides a display device includes a display panel that has a display area and a non-display area enclosing the display area, a transparent protective unit that is positioned at the front of the display panel, an adhesive layer that is formed between the display area and the transparent protective unit to attach the transparent protective unit to the display panel, an adhesive tape that is positioned between the non-display area and the transparent protective unit while enclosing the adhesive layer and that forms at least one opening; and a bezel that is coupled to the display panel at the rear of the display panel.

The adhesive layer may be made of a transparent synthetic resin material. The adhesive tape may be formed with a double-sided adhesive tape having two adhesive surfaces. The adhesive layer and the adhesive tape may have a thickness of 0.15 to 0.25 mm. The adhesive tape may form a pair of longitudinal sides and a pair of lateral sides, and an opening of the adhesive tape may be positioned at each of the pair of longitudinal sides and the pair of lateral sides.

The bezel may include a bottom portion at which the display panel is placed, and a side wall that is extended toward the transparent protective unit from an edge of the bottom portion. A height of the side wall may be equal to or greater than the sum of a thickness of the display panel and a thickness of the adhesive layer.

The display panel may include a front substrate and a rear substrate. A polarizing film may be positioned at an outer surface of the front substrate, and the adhesive layer may have the same refractive index as that of the transparent protective unit. A polarizing film may be positioned at an outer surface of the transparent protective unit, and the adhesive layer may have the same refractive index as that of the transparent protective unit and the front substrate. The display panel may be an organic light emitting diode (OLED) display panel.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicated the same or similar components, wherein:

FIG. 1 is an exploded perspective view of a display device according to a first exemplary embodiment of the present invention.

FIG. 2 is a perspective view illustrating a coupled state of the display device that is shown in FIG. 1.

FIG. 3 is a partial cross-sectional view of a dotted line portion that is taken along line I-I of FIG. 2.

FIG. 4 is a partial cross-sectional view of a display device according to a second exemplary embodiment of the present invention.

FIG. 5 is a schematic diagram of an organic light emitting diode (OLED) display panel.

FIG. 6 is a partial cross-sectional view of an OLED display panel.

### DETAILED DESCRIPTION OF THE INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

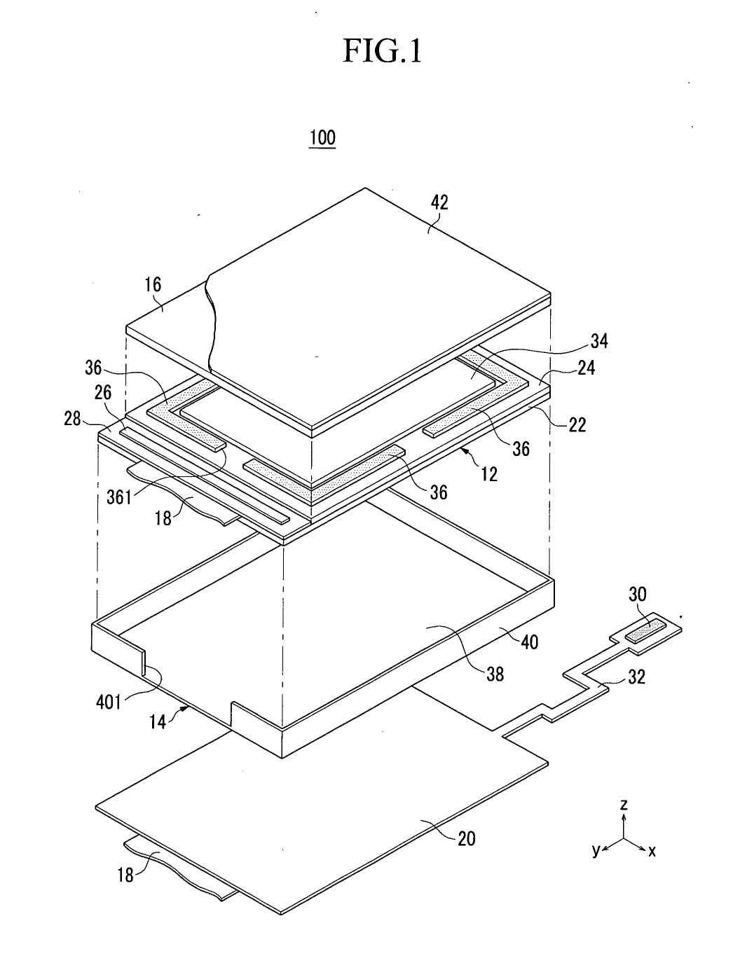

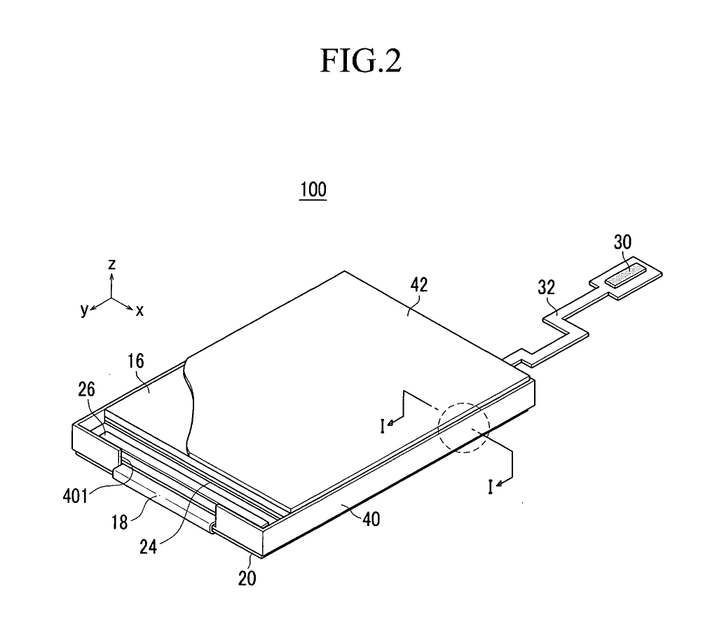

FIG. 1 is an exploded perspective view of a display device according to a first exemplary embodiment of the present invention, and FIG. 2 is a perspective view illustrating a coupled state of the display device that is shown in FIG. 1.

Referring to FIGS. 1 and 2, a display device 100 of the present exemplary embodiment includes a display panel 12 that displays an image, a bezel 14 that is disposed at the rear of the display panel 12 to receive and fix the display panel 12 and various parts, and a transparent protective unit 16 that is disposed at the front of the display panel 12 to protect the display panel 12.

The display panel 12 may be an organic light emitting diode (OLED) display panel. Alternatively, the display panel 12 may be another display panel, for example a liquid crystal display panel. The display panel 12 is electrically connected to a printed circuit board (PCB) 20 through a flexible printed circuit board (FPCB) 18. In FIG. 1, for convenience, the FPCB 18 is shown to be cut, but the FPCB 18 is actually connected as shown in FIG. 2.

Pixels, which are a basic unit of image expression, are arranged in a matrix format on a first substrate 22 of the display panel 12, and a second substrate 24 is bonded to the first substrate 22 through a sealing member (not shown) to protect the pixels. The first substrate 22 may be a rear substrate, and the second substrate 24 may be a front substrate.

As an example, in an active matrix type of OLED display panel, a pixel includes an organic light emitting element (not shown) that includes an anode electrode, an organic emission layer, and a cathode electrode, and a driving circuit (not shown) that drives the organic light emitting element. The driving circuit may be a TFT. A data line is connected to a source terminal of the TFT, and a gate line is connected to a gate terminal thereof. One of the anode electrode and the cathode electrode of the organic light emitting element is connected to a drain terminal thereof.

The data line and the gate line of the TFT are connected to the PCB 20 through the FPC 18. When an electric signal is input to the source terminal and the gate terminal of the TFT through the PCB 20, the TFT is turned on or turned off according to the input signal to output an electric signal that is necessary for driving a pixel to the drain terminal.

An integrated circuit chip 26 is mounted on the first substrate 22 to control the display panel 12. The integrated circuit chip 26 generates timing signals for applying a data driving signal and a gate driving signal at an appropriate time. The integrated circuit chip 26 applies each of the signals to a data line and a gate line of the display panel 12. A protective layer 28 is formed around the integrated circuit chip 26 to protect the integrated circuit chip 26.

Electronic elements (not shown) for processing a driving signal are mounted in the PCB 20. The PCB 20 includes a connector 30 and an extension unit 32, and the extension unit 32 transmits an outside signal that is transferred to the connector 30 to the PCB 20. In a cellular phone, the connector 30 can be connected to a keypad.

The transparent protective unit 16 that protects the display panel 12 is positioned at the front of the display panel 12. The transparent protective unit 16 may be made of a synthetic resin material, and performs a function of protecting the display panel 12 from breaking by an external impact.

A predetermined thickness of an adhesive layer 34 and an adhesive tape 36 that encloses the adhesive layer 34 are positioned between the display panel 12 and the transparent protective unit 16 to attach the transparent protective unit 16 to the display panel 12. The adhesive layer 34 and the adhesive tape 36 protect the display panel 12 together with the transparent protective unit 16 to improve impact-resistance integrity of the display device 100. The adhesive layer 34 may be made of a transparent synthetic resin material, and the adhesive tape 36 may be formed as a double-sided adhesive tape having two adhesive surfaces of an upper surface and a lower surface.

The adhesive layer 34 is formed with the same size as that of a display area of the second substrate 24, and is positioned at an upper part of the display area. The adhesive tape 36 is positioned at a non-display area that encloses the display area. The transparent protective unit 16 is formed with an area that is greater than that defined by outer edges of the adhesive tape 36, for example with the same size as that of the second substrate 24. An air gap does not exist between the display area and the transparent protective unit 16 because of the adhesive layer 34.

The adhesive layer 34 is formed with a uniform thickness on the display area, and the thickness thereof can be adjusted as needed. For example, the adhesive layer 34 can be formed with a thickness of 0.15 to 0.25 mm. If the thickness of the adhesive layer 34 is less than 0.15 mm, impact-resistance integrity thereof deteriorates, and the display panel 12 may be damaged by an external impact. If the thickness of the adhesive layer 34 exceeds 0.25 mm, because material consumption increases without increasing impact-resistance intensity, production cost may increase.

The adhesive tape 36 can be formed with a uniform width, and performs a function of a guide when the adhesive layer 34 is formed. That is, the adhesive layer 34 can be formed by attaching the adhesive tape 36 to the non-display area of the second substrate 24, and coating and pressing a liquid high polymer resin on the display area of the second substrate 24. In this process, the adhesive tape 36 confines the high polymer resin to the inside thereof as a guide to form the adhesive layer 34.

Further, at least one opening 361 for discharging bubbles is formed in the adhesive tape 36. The opening 361 performs a function of discharging bubbles to the outside when coating and pressing the liquid high polymer resin at the inside of the adhesive tape 36. Therefore, because the completed adhesive layer 34 does not contain bubbles, when light that is emitted from the display panel 12 passes through the adhesive layer 34, visibility is not deteriorated.

The adhesive tape 36 may form a pair of longitudinal sides and a pair of lateral sides, and one opening 361 may be formed in each of the pair of longitudinal sides and the pair of lateral sides. FIG. 1 illustrates, as an example, one opening 361 positioned at each of the center of a longitudinal side and the center of a lateral side of the adhesive tape 36. The position, size, and number of openings 361 are not limited to the illustrated example, and can be variously changed.

As the adhesive tape 36 performs a function of guiding the adhesive layer 34, the thickness of the adhesive layer 34 is determined by the thickness of the adhesive tape 36. Therefore, by forming the adhesive tape 36 at a thickness of 0.15 to 0.25 mm, the adhesive layer 34 can be formed at the same thickness.

Because the adhesive layer 34 and the adhesive tape 36 have a smaller thickness than a conventional air gap (an interval between a display panel and a transparent protective unit), the adhesive layer 34 and the adhesive tape 36 contribute to slimness of the display device 100. Further, the display panel 12 of the display device 100 can be more safely protected from an external impact that is applied to the front of the display panel 12 and an upper bezel that is generally disposed at the circumference of the transparent protective unit 16 to be coupled to the bezel 14 may be omitted, thereby simplifying the structure and manufacture thereof.

The bezel 14 is positioned between the display panel 12 and the PCB 20, and receives and fixes the display panel 12 and various parts at the inside thereof at the rear of the display panel 12. The bezel 14 is made of a material having greater integrity than the transparent protective unit 16. For example, the bezel 14 is made of a metal material such as stainless steel, cold rolled steel, and an aluminum-nickel-silver alloy.

The bezel 14 includes a bottom portion 38 that comes in contact with the first substrate 22 of the display panel 12, and a side wall 40 that is extended toward the transparent protective unit 16 from an edge of the bottom portion 38. The side wall 40 has an opening 401 through which the FPCB 18 passes, and encloses and supports a side surface of the display panel 12 except for a portion at which the opening 401 is formed.

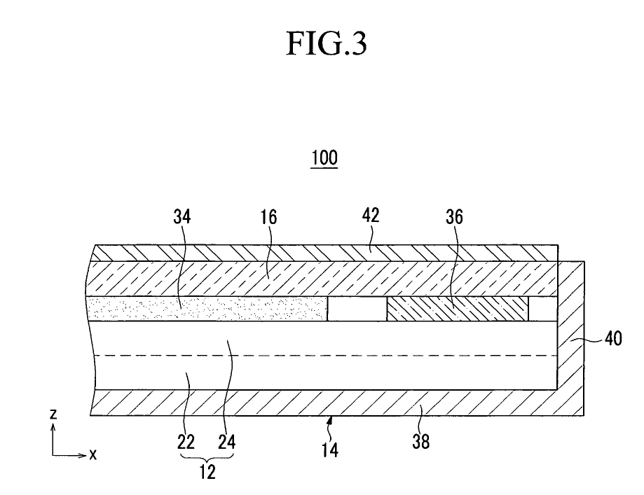

FIG. 3 is a partial cross-sectional view of a dotted line portion that is taken along line I-I of FIG. 2.

Referring to FIG. 3, a height of the side wall 40 of the bezel 14 is equal to or greater than the sum of a thickness of the display panel 12 and a thickness of the adhesive layer 34 or the adhesive tape 36. Therefore, the side wall 40 encloses a side surface of the display panel 12 and the outside of the adhesive tape 36 to protect them.

For example, as shown in FIG. 3, the height of the side wall 40 may be equal to the sum of a thickness of the display panel 12, a thickness of the adhesive layer 34 or the adhesive tape 36, and a thickness of the transparent protective unit 16. In this case, the side wall 40 encloses the side surface of the display panel 12, the outside of the adhesive tape 36, and a side surface of the transparent protective unit 16 to support them. The shape and height of the side wall 40 are not limited to the above-described example, and can be variously changed.

In this way, in the display device 100 of the present exemplary embodiment, as the adhesive layer 34 and the adhesive tape 36 are positioned between the display panel 12 and the transparent protective unit 16, the entire thickness thereof can be reduced and impact-resistance integrity can be improved. By using the bezel 14 of the above-described structure, the display panel 12 and the transparent protective unit 16 can be firmly fixed.

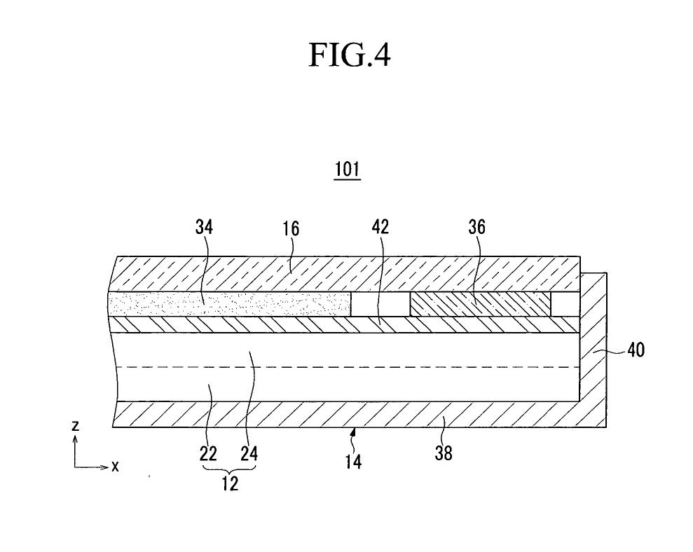

Further, in the present exemplary embodiment, as shown in FIG. 3, a polarizing film 42 is disposed at an outer surface of the transparent protective unit 16, and the adhesive layer 34 may have the same refractive index as that of the transparent protective unit 16 and the second substrate 24 of the display panel 12. Alternatively, in the second exemplary embodiment of the present invention as shown in FIG. 4, the polarizing film 42 is disposed at an outer surface of the second substrate 24, and the adhesive layer 34 may have the same refractive index as that of the transparent protective unit 16.

In the display device 100 that is shown in FIG. 3, external light is reflected only from a surface of the polarizing film 42, and external light reflection generated at an upper surface of the transparent protective unit 16, an upper surface of the adhesive layer 34, and an upper surface of the second substrate 24 can be eliminated. In a display device 101 that is shown in FIG. 4, external light reflection generated at the upper surface of the adhesive layer 34 can be eliminated.

Therefore, the display devices 100 and 101 of the first and second exemplary embodiments can improve external light visibility (visibility that is measured in a condition in which external light exists the device).

An organic light emitting diode (OLED) display panel, which is a kind of a display panel, is described hereinafter.

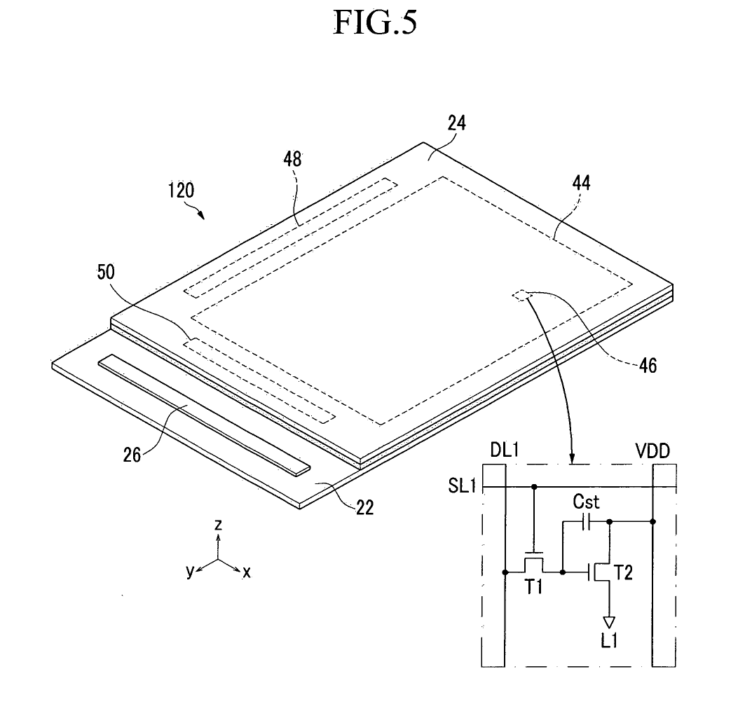

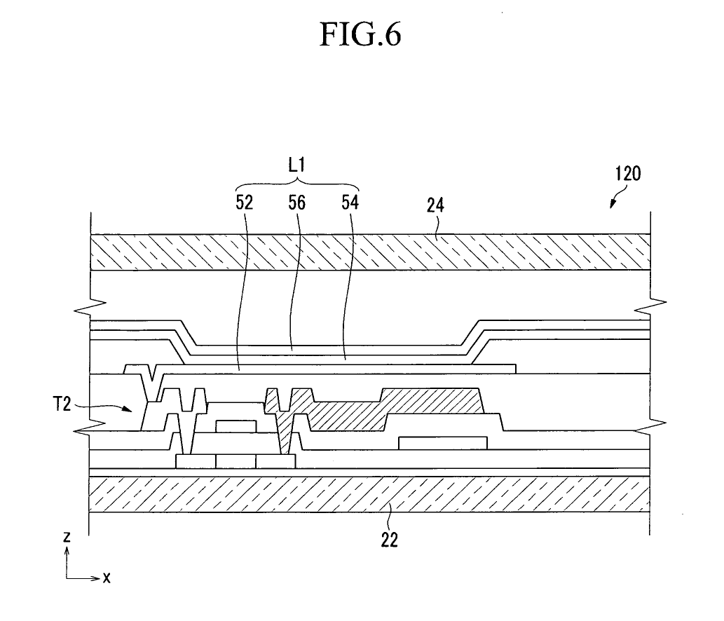

FIG. 5 is a schematic diagram of an OLED display panel, and FIG. 6 is a partial cross-sectional view of an OLED display panel and illustrates one sub-pixel area.

Referring to FIGS. 5 and 6, in a color OLED display panel 120, a plurality of sub-pixels 46 are disposed in a matrix format in a display area 44 of the first substrate 22, and a scan driver 48 and a data driver 50 that drive the sub-pixels 46 are positioned at the outside of the display area 44.

Each sub-pixel 46 includes an organic light emitting element L1 and a driving circuit, and the organic light emitting element L1 includes an anode electrode 52, an organic emission layer 54, and a cathode electrode 56. The driving circuit includes, as an example, a switching first thin film transistor (hereinafter referred to as a “first TFT”) T1, a driving second thin film transistor (hereinafter referred to as a “second TFT”) T2, and a storage capacitor Cst. FIG. 6 shows the second TFT T2.

The first TFT T1 is connected to a scan line SL1 and a data line DL1, and transmits a data voltage that is input from the data line DL1 to the second TFT T2 according to a switching voltage that is input to the scan line SL1. The storage capacitor Cst is connected to the first TFT T1 and a power line VDD, and stores a voltage Vgs corresponding to a difference between a voltage that is received from the first TFT T1 and a voltage that is supplied to the power line VDD.

The second TFT T2 is connected to the power line VDD and the storage capacitor Cst to supply an output current that is in proportion to the square of a difference between a voltage Vgs that is stored in the storage capacitor Cst and a threshold voltage Vth to an organic light emitting element L1, and the organic light emitting element L1 emits light by an output current.

For a display device to which the OLED display panel is applied, optical characteristics that are measured in a display device of a comparative example and display devices of Exemplary Embodiments 1 and 2 are represented in Table 1. In the display device of the comparative example, an adhesive layer is not provided and a polarizing film is attached to an outer surface of the second substrate. The display devices of Exemplary Embodiments 1 and 2 have an adhesive layer, and in Exemplary Embodiment 1, a polarizing film is attached to an outer surface of a transparent protective unit, while in Exemplary Embodiment 2, a polarizing film is attached to an outer surface of a second substrate.

TABLE 1

| | Comparative | Exemplary | Exemplary |
|---|---|---|---|
| | Example | Embodiment 1 | Embodiment 2 |
| Luminance (cd/m²) | 180 | 206 | 206 |
| | (100%) | (114%) | (114%) |
| External light contrast | 1.74 | 6 | 2.45 |
| ratio | | | |
| (at 10,000 lux) | | | |
| External light color | 5.3 | 42.6 | 14.5 |
| representation | | | |
| (at 10,000 lux) | | | |
| Transmittance of | 91.8 | 91.8 | 91.8 |
| transparent protective | | | |
| unit (%) | | | |
| Reflectivity of | 7.44 | 1 or less | 4.35 |
| transparent protective | | | |
| unit + display panel | | | |
| (%) | | | |

As described in Table 1, the display devices of Exemplary Embodiments 1 and 2 show improved results in terms of luminance, external light contrast ratio, and external light color representation, compared with the display device of the comparative example. Further, in the display device of Exemplary Embodiment 1, the external light contrast ratio and external light color representation are remarkably improved and reflectivity of a transparent protective unit and a display panel are remarkably reduced, compared with the display device of Exemplary Embodiment 2.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a display panel that has a display area and a non-display area enclosing the display area;
a transparent protective unit that is positioned at the front of the display panel;
an adhesive layer that is formed between the display area and the transparent protective unit to attach the transparent protective unit to the display panel;
an adhesive tape that is positioned between the non-display area and the transparent protective unit while enclosing the adhesive layer and that has at least one opening; and
a bezel that is coupled to the display panel at the rear of the display panel.

2. The display device of claim 1, wherein the adhesive layer is made of a transparent synthetic resin material.

3. The display device of claim 2, wherein the adhesive tape is formed as a double-sided adhesive tape having two adhesive surfaces.

4. The display device of claim 1, wherein the adhesive layer and the adhesive tape have a thickness of 0.15 to 0.25 mm.

5. The display device of claim 1, wherein the adhesive tape forms a pair of longitudinal sides and a pair of lateral sides, and an opening of the adhesive tape is positioned at each of the pair of longitudinal sides and the pair of lateral sides.

6. The display device of claim 1, wherein the bezel comprises a bottom portion at which the display panel is placed and a side wall that is extended toward the transparent protective unit from an edge of the bottom portion.

7. The display device of claim 6, wherein a height of the side wall is equal to or greater than the sum of a thickness of the display panel and a thickness of the adhesive layer.

8. The display device of claim 1, wherein the display panel further comprises:
a front substrate;
a rear substrate; and
a polarizing film positioned at an outer surface of the front substrate,
wherein the adhesive layer has the same refractive index as that of the transparent protective unit.

9. The display device of claim 1, wherein the display panel further comprises:
a front substrate;
a rear substrate; and
a polarizing film positioned at an outer surface of the transparent protective unit,
wherein the adhesive layer has the same refractive index as that of the transparent protective unit and the front substrate.

10. The display device of claim 1, wherein the display panel is an organic light emitting diode (OLED) display panel.

11. A display device having a display panel with a display area and a non-display area surrounding the display area, comprising:
an adhesive layer disposed on said display area;
an adhesive tape disposed on said non-display area on the same side of the display panel as the adhesive layer; and
a transparent protective unit attached to said adhesive tape,
wherein said adhesive layer and said adhesive tape both have a thickness of 0.15 mm to 0.25 mm,
wherein said adhesive tape has at least one opening sufficient to allow air bubbles to escape.

12. The display device recited in claim 11, further comprising:
a polarizing film disposed on an opposite side of said transparent protective unit from that of the adhesive tape.

13. The display device recited in claim 11, wherein the display panel is an organic light emitting diode (OLED) display panel.

14. The display device recited in claim 11, wherein the adhesive layer is made of a transparent synthetic resin material.

15. The display device recited in claim 11, wherein the adhesive tape is formed as a double-sided adhesive tape having two adhesive surfaces.

16. The display device recited in claim 11, wherein the adhesive layer has the same refractive index as that of the transparent protective unit.

17. The display device recited in claim 11, wherein the display panel further comprises:
a front substrate;
a rear substrate; and
a polarizing film positioned at an outer surface of the front substrate,
wherein the adhesive layer has the same refractive index as that of the transparent protective unit.

18. The display device of claim 11, wherein the display panel further comprises:
a front substrate;
a rear substrate; and
a polarizing film positioned at an outer surface of the transparent protective unit,
wherein the adhesive layer has the same refractive index as that of the transparent protective unit and the front substrate.
